(19) United States
(12) Patent Application Publication
(10) Pub. No.: US 2014/0067676 A1
(43) Pub. Date: Mar. 6, 2014

(54) MANAGEMENT OF DIGITAL RECEIPTS

(71) Applicant: MICROSOFT CORPORATION, Redmond, WA (US)

(72) Inventors: Zachary Woodall, Sammamish, WA (US); Nidal Saleh, Bothell, WA (US); Saral Shodhan, Kirkland, WA (US); Rahul Dhar, Seattle, WA (US); Michael Fischer, Beijing (CN)

(73) Assignee: MICROSOFT CORPORATION, Redmond, WA (US)

(21) Appl. No.: 13/716,000

(22) Filed: Dec. 14, 2012

Related U.S. Application Data
(60) Provisional application No. 61/696,664, filed on Sep. 4, 2012.

(51) Int. Cl. G06Q 20/04

(52) U.S. Cl. CPC G06Q 20/0453
USPC 705/44; 705/35

(57) ABSTRACT

Digital receipts for purchases can be managed using a variety of techniques. Digital receipts can be obtained by an application running on a computing device and can be authenticated when not connected to a server, such as when offline. Digital receipts can be efficiently synchronized, such as when connected to a network for other reasons. A last synchronization timestamp can be obtained and sent to a server environment and digital receipts can be received that are new and/or have been updated since the last synchronization timestamp.

### CROSS-REFERENCE TO RELATED APPLICATION

This application claims the benefit of U.S. Provisional Application No. 61/696,664, filed Sep. 4, 2012, which is incorporated by reference herein.

### BACKGROUND

Software applications, such as mobile software apps, can include the ability for the user of the application to purchase digital goods for use with the application. For example, a game application can include the ability for the user to purchase in-game items. Similarly, a music application can include the ability for the user to purchase music.

Software sellers need a way to establish a customer's identity and verify that the customer has paid for the digital goods. In a situation where a mobile device is connected intermittently, it can be important that software developers be able to provide products and services their customers have purchased without requiring a persistent or constant connection to the Internet.

In order to ensure that such digital goods have been purchased legitimately, software applications can verify purchase information by connecting to a server. However, it may not be possible to verify purchase information when the software application is unable to connect to the server.

Therefore, there exists ample opportunity for improvement in technologies related to managing digital receipts.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Techniques and tools are described for managing digital receipts for purchased content (e.g., digital goods and/or services). For example, digital receipts can be synchronized and stored locally at a mobile device. The digital receipts can be authenticated by the mobile device when the mobile device is offline (e.g., the authentication can be performed without requiring a connection to a server).

For example, a method can be provided for managing digital receipts for purchases. The method comprises receiving, from a local application running on a mobile computing device, a request for receipts associated with the local application, obtaining, from a receipt store of the mobile computing device, receipts associated with the local application, and providing, to the local application, the obtained receipts, where the obtained receipts are authenticated locally by the mobile computing device when the mobile computing device is offline.

As another example, a method can be provided for managing digital receipts for purchases. The method comprises, by the mobile computing device, performing a delta sync comprising obtaining a last synchronization timestamp, sending the last synchronization timestamp to a server environment, receiving, from the server environment, one or more receipts, where the one or more receipts are new since the last synchronization timestamp and/or have been updated since the last synchronization timestamp, and saving the received one or more receipts in a receipt store.

As another example, server systems comprising processing units and memory can be provided for performing operations described herein. For example, a server system can be provided for signing digital receipts using digital signatures, providing digital receipts to mobile computing devices, responding to synchronization requests, etc.

As described herein, a variety of other features and advantages can be incorporated into the technologies as desired.

### BRIEF DESCRIPTION OF THE DRAWINGS

FIG. 1 is a block diagram of an example environment for managing digital receipts.

FIG. 2 is a flowchart of an example method for managing digital receipts supporting offline authentication.

FIG. 3 is a flowchart of an example method for synchronizing digital receipts.

FIG. 4 is a diagram of an example control flow for making a purchase and generating a digital receipt.

FIG. 5 is a diagram of an example control flow for synchronizing digital receipts.

FIG. 6 is a diagram of an exemplary computing system in which some described embodiments can be implemented.

FIG. 7 is an exemplary mobile device that can be used in conjunction with the technologies described herein.

FIG. 8 is an exemplary cloud-support environment that can be used in conjunction with the technologies described herein.

### DETAILED DESCRIPTION

### Example 1

### Overview

As described herein, various techniques and solutions can be applied to managing digital receipts. For example, digital receipts can be authenticated when a device (e.g., a mobile computing device) is offline. Digital receipts can also be synchronized between a device and a server environment.

Managing digital receipts when a device is offline refers to the ability of the device to locally manage digital receipts without requiring a connection (e.g., Internet connection) to another device, such as a server. For example, when a device authenticates a digital receipt offline, it authenticates the digital receipt locally (e.g., via a receipt service and/or application running on the device) without connecting to an external device (e.g., via a wireless network connection, such as Wi-Fi network or cellular network). A device can manage digital receipts offline (e.g., perform offline digital receipt operations, such as authentication) even when the device is connected to a network (e.g., connected to a Wi-Fi or cellular network) if the device is not using the network (e.g., not connecting to a remote server) to perform the offline operations (e.g., authentication operations).

A digital receipt can be a receipt for a purchase (e.g., a transaction), such as a purchase for content related to an application (e.g., a local application running on the mobile device). A software application (app) running on a computing device (e.g., a mobile phone, tablet, or other type of mobile computing device) can be provided by an independent software vendor (ISV), which can refer to an entity that develops or sells a software application.

Receipts can be signed using a digital signature. Receipts can be signed by an entity (e.g., a trusted entity). For example, receipts can be digitally signed by an operating system provider of a mobile computing device.

### Example 2

### Digital Receipts

In any of the examples herein, a digital receipt refers to any type of document in a digital format that identifies a purchase or transaction and that supports digital authentication and/or validation. For example, a digital receipt can be a receipt for content purchased for use with an application. Content can be purchased by an application from an application store.

A digital receipt can comprise information (e.g., meta-data) describing the purchase. For example, one or more of the following types of information can be included in a receipt:
A unique identifier for the purchase (e.g., a unique transaction identifier).
An identifier for the content that was purchased.
A unique identifier for the device on which the purchase was made.
A unique identifier for the user that made the purchase (e.g., a unique account identifier).
Other information related to the purchase, such as the purchase price, the type of content that was purchased (e.g., consumable content or durable content), etc.

The unique identifiers can be anonymized. For example, unique identifiers (e.g., for the user and device) can be anonymized to protect the user's privacy.

### Example 3

### Authenticating Digital Receipts

In any of the examples herein, digital receipts can be authenticated. For example, digital receipts can be signed using a digital signature (e.g., signed by a trusted entity, such as a software manufacturer or operating system provider). The digital receipts can then be authenticated using, at least in part, the digital signature.

Authentication can be performed by authenticating a digital signature associated with a digital receipt. Various types of authentication systems and digital signatures can be used for performing the authentication. In a specific implementation, digital signatures and authentication are implemented using XML Signature (XML-DSig), which is a digital signature standard published by W3C.

### Example 4

### Environment for Managing Digital Receipts

In any of the examples herein, methods can be provided for authenticating digital receipts. For example, purchases can be made for content associated with applications. Digital receipts for the content purchases can be downloaded and stored locally (e.g., on a mobile computing device). Digital receipts can be locally authenticated (e.g., without having to connect to another device, such as a server). The content associated with a digital receipt can be redeemed (e.g., activated or used) once the digital receipt has been authenticated. Digital receipts can be synchronized. For example, digital receipts can be downloaded by a client device from a server environment for one or more apps installed on the client device.

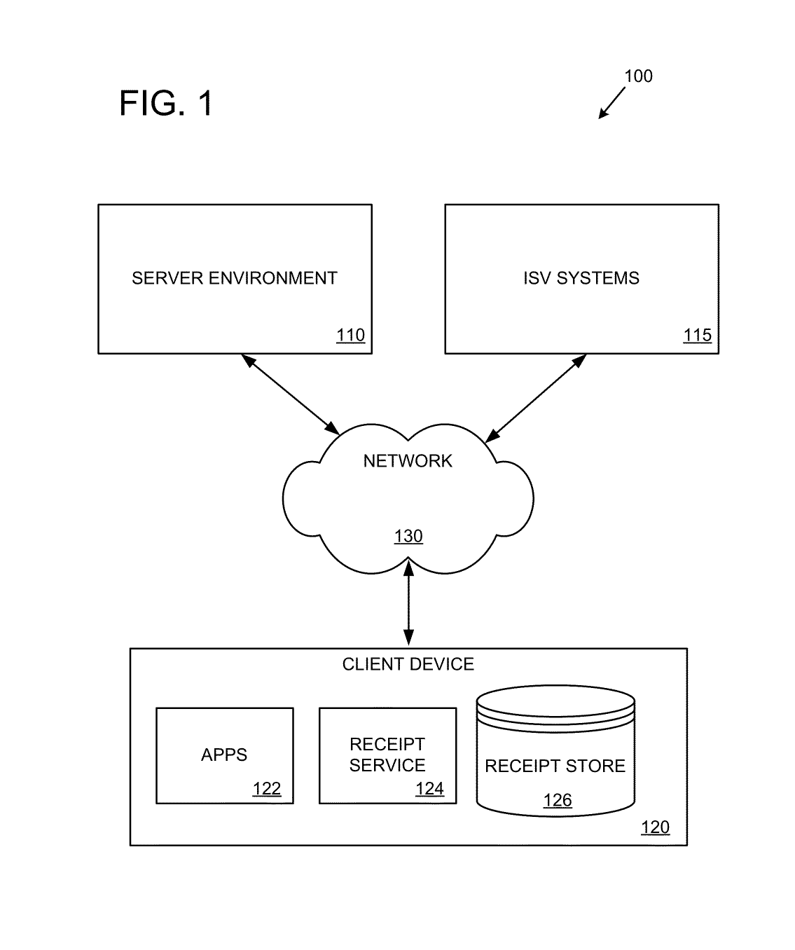

FIG. 1 is a diagram depicting an example environment 100 for managing digital receipts. The example environment 100 includes a server environment 110. For example, the server environment 110 can comprise one or more computer servers, database servers, network equipment, and/or other server environment related components and devices. The server environment 110 can be provided as a cloud computing environment. The server environment 110 can provide application services, such as an application store (app store).

The example environment 100 includes independent software vendor (ISV) systems 115. For example, the ISV systems 115 can comprise server computers, databases servers, and/or other computing resources. The ISV systems 115 can represent systems associated with one or more ISVs.

The example environment 100 also includes a client device 120 connected to the server environment 110 via a network 130 (e.g., net Internet and/or other types of network connections, such as Wi-Fi and/or cellular connections). The client device 120 comprises applications (apps) 122, a receipt service 124, and a receipt store 126.

The client device 120 can manage digital receipts. For example, the client device 120 can receive digital receipts from the server environment 110. The client device 120 can store the digital receipts in the receipt store 126. The client device 120 can authenticate the digital receipts (e.g., offline without connecting to the server environment 110). For example, the client device 120 can authenticate the digital receipts using, at least in part, the receipt service 124 (e.g., by authenticating digital signatures associated with the digital receipts). Once authenticated, the digital receipts can be utilized by the apps 122. For example, an app can enable purchased content (e.g., a song, an in-game item, a new game level, or another type of content), as specified by an authenticated digital receipt.

The client device 120 can also synchronize receipts. For example, when one of the apps 122 of the client device 120 connects to the server environment 110 (e.g., for a reason other than synchronizing receipts, which can be called an opportunistic synchronization), the client device 120 can synchronize receipts for the application (e.g., just for the application that initiated the connection). Alternatively, synchronization can be performed for all apps 122. The synchronization can be performed to synchronize any new and/or updated digital receipts that are stored at the server environment 110 (e.g., in a receipt cache, not pictured). The new and/or updated receipts can be retrieved and stored in the receipt store 126. Performing a synchronization when the client device 120 is already connected to the network 130 and/or server environment 110 for another reason can save resources, such as battery power and/or bandwidth.

The client device 120 can also synchronize receipts at other times. For example, the client device 120 can perform a daily (e.g., at night) synchronization (e.g., if the client device 120 is on a/c power and connected to a Wi-Fi network). In some implementations, a full synchronization is performed on a periodic basis (e.g., weekly or monthly).

The client device 120 can also communicate with the ISV systems 115 to perform various operations related to the applications 122 and/or the digital receipts (e.g., stored in the receipt store 126), such as unlocking and delivering products, tracking purchases, and/or fulfilling purchases. For example, an application of the client device (e.g., one of the apps 122) can obtain a digital receipt (e.g., from the receipt store 126) and transmit the digital receipt to the ISV that provided the application (e.g., by communicating with the ISV's systems 115). Alternatively, the receipt service 124 can transmit or provide the digital receipt to the ISV (or respond to a request from the ISV). In response, the ISV can perform various operations based on the received digital receipt (e.g., based on meta-data contained in the digital receipt), such as verifying purchase authenticity, unlocking and delivering a product, tracking purchases, fulfilling purchases, etc.

### Example 5

### Methods for Authenticating Digital Receipts

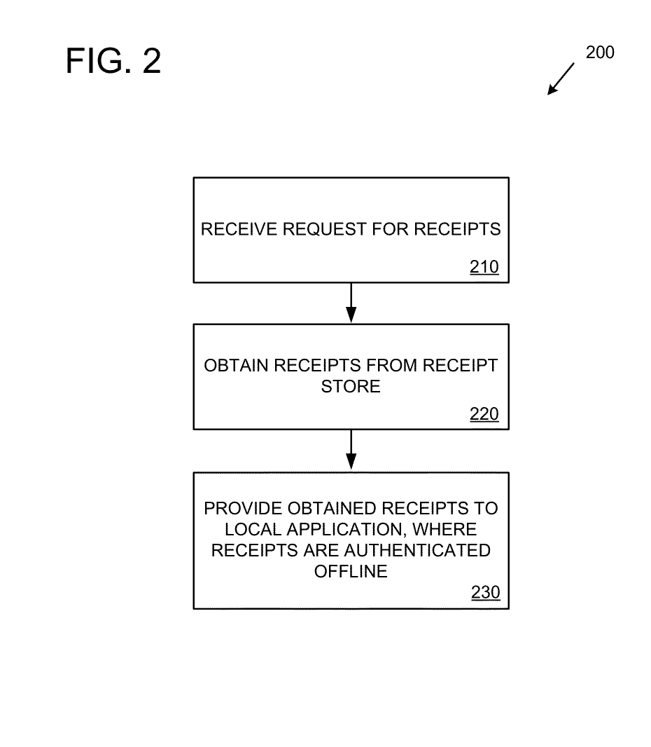

In any of the examples herein, methods can be provided for managing digital receipts. FIG. 2 is a flowchart of an example method 200 for managing digital receipts. At 210, a request for receipts is received from a local application installed on a mobile computing device. At 220, receipts are obtained from a receipt store located at the mobile computing device. At 230, the obtained receipts are provided to the local application. The receipts are authenticated offline. For example, the receipts can be authenticated by the local application and/or a receipt service running on the mobile computing device. The receipts can be authenticated using digital signatures associated with the receipts.

### Example 6

### Synchronizing Digital Receipts

In any of the examples herein, digital receipts can be synchronized. For example, receipts can be synchronized between a server environment (e.g., one or more server computers, a distributed server environment, and/or a cloud environment) and one or more client computing devices (e.g., mobile computing devices and/or other types of computing devices).

Synchronization can be performed in an efficient manner (e.g., to save resources, such as battery power). For example, synchronization (e.g., opportunistic synchronization) of digital receipts can be performed when a mobile computing device (e.g., a mobile phone, tablet, or other type of mobile computing device) connects to a network for a reason other than to synchronize receipts, such as when downloading web content, retrieving email messages, making an app purchase, etc. In a specific implementation, when an application running on a mobile computing device (a local application) connects via a network (e.g., via a Wi-Fi network connection, via a cellular data network connection, etc.) to make a purchase (e.g., an in-app purchase of content), the mobile computing device can synchronize receipts associated with the local application (e.g., receipts for content related to the local application that were purchased from a different computing device).

There can be cases where a client mobile computing device is online and offline intermittently. Information on the server environment may not be what is on the mobile device (e.g., content may have been purchased from a different device). In order to limit the amount of resources used on a mobile device (e.g., battery, bandwidth, etc.), opportunistic synchronization can be used (e.g., synchronize when already connected to a network and/or server environment for a different purpose).

Synchronization can be performed to synchronize digital receipts according to a current context. For example, the current context can comprise the mobile computing device being used and/or local application being used. For example, if a local application connects to a server to make a purchase, then any new and/or updated digital receipts can be downloaded that are associated with the local application and that are new and/or updated with respect to the digital receipts already present on the mobile computing device (e.g., in a receipt store).

In a specific implementation, when a local application connects to the server (e.g., to make a purchase or for another reason), then all digital receipts associated only with the local application that initiated the application are synchronized (i.e., digital receipts associated with other local applications are not synchronized). Performing opportunistic synchronization when a local application connects to the server can save resources (e.g., battery, bandwidth, storage). In other implementations, digital receipts associated with other local applications (e.g., all other installed local applications) are synchronized as well.

A full sync can be performed on a periodic basis (e.g., nightly). For example, if a mobile device is using a/c power and connected to Wi-Fi, then the mobile device can automatically do a full sync (e.g., a delta sync for all applications installed on the mobile device) on a periodic basis (e.g., a daily basis, such as at night).

In some implementations, before doing a purchase via an application, an opportunistic sync is performed that just syncs receipts for that application. In other implementations, a full sync is performed (e.g., for more than just the application making the purchase, such as all applications on the mobile device that could have receipts to sync).

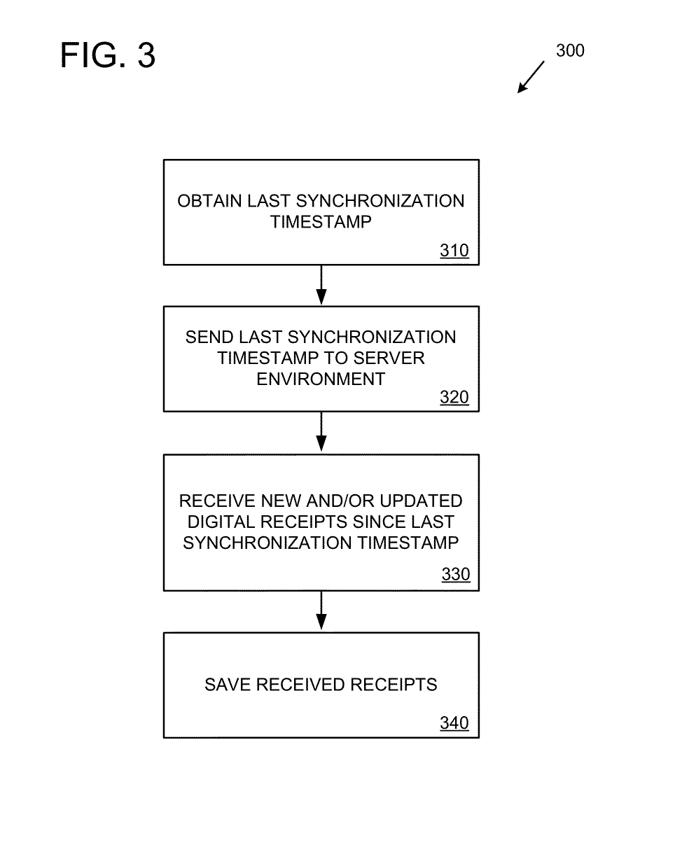

FIG. 3 is a flowchart of an example method 300 for managing digital receipts for purchases, including performing a delta sync. At 310, a last synchronization timestamp is obtained (e.g., by a mobile computing device). At 320, the last synchronization timestamp is sent to a server environment. At 330, new and/or updated digital receipts (that are new and/or updated since the last synchronization timestamp) are received from the server environment. At 340, the received receipts are stored (e.g., in a receipt store). The received receipts can also be authenticated.

The last synchronization timestamp can be updated to a present timestamp so that when the next delta sync is performed new and/or updated receipts are received (that are new and/or updated since receipts received at 330).

### Example 7

### Managing Digital Receipts

In any of the examples herein, management of digital receipts can be performed by a mobile computing device. At least some of the management operations for the digital receipts can be performed by the mobile computing device while the mobile computing device is offline. Management of digital receipts can include authentication and/or verification of receipts, synchronization of receipts, and/or other operations related to receipts.

Receipts can be digitally signed by a trusted entity, such as an operating system provider of an operating system running on a mobile device. Digital signatures can add a level of protection and security beyond what an ISV (e.g., application developer or publisher) can achieve by storing state of ownership in the local isolated storage for their app.

It is possible that purchases have been fulfilled that the ISV's code was not made aware of, as in the case of a purchase from a different device, or a purchase that completed in the background after closing of the ISV's app. In order for these receipts to be available for use at the computing device, they can be synchronized. For example, synchronization can be performed to download any receipts that are not yet stored at the computing device (e.g., in the receipt store of the computing device). In some implementations, synchronization is only performed for receipts of durable content (e.g., and not for receipts of consumable content).

In some implementations, an application calls a local receipt service (e.g., via an application programming interface (API)) to manage receipts (e.g., when the application is starting, and/or at other times). Calling the receipt service can cause receipts for the application to be synchronized (e.g., any new receipts not already in the receipt store can be downloaded and stored). Calling the receipt service can also cause authentication to be performed for receipts (e.g., to authenticate purchases of content).

The receipt service can be designed to return results quickly (e.g., to return 100 receipt results in less than one second). The receipt service can provide results without connecting to a server (e.g., when offline). Providing a local receipt store allows a mobile device to access receipts without expending resources (e.g., battery and network bandwidth) needed to connect to a remote server.

Although it is possible for receipt requests to be made online (e.g., to a remote server), a default setting can be applied where receipt requests are handled locally offline (e.g., via a local receipt store). In some implementations, a receipt request can queue a synchronization action to be performed at a later time.

In some implementations, one or more of the following synchronization (sync) procedures can be applied:
Sync can be done on a per-app basis
Scheduled sync can be performed:
   on WiFi
      Standard battery settings: queued delta-syncs happen immediately
      Battery saver mode: delta-sync will happen when plugged into a/c power
   on cellular data network
      Standard data settings: sync will be queued and batched in a single daily call
      Low data use settings: sync will be paused and executed on a monthly refresh task
      Sync can be deferred while roaming

Synchronization can be performed based on when receipts were last synchronized. This type of synchronization can be called a delta-sync. In some implementations, a client (e.g., a mobile computing device) sends a last sync timestamp (e.g., comprising date and/or time information) to a server environment, which returns new and/or updated receipts since the last sync timestamp. The server environment's response can include an updated sync timestamp that can be cached by the client and used, as the last sync timestamp, for the next delta-sync request.

Synchronization can be performed when an application is first installed or reinstalled. For example, a user may purchase a new mobile device, such as a new mobile phone. The user could reinstall one or more apps that the user previously purchased. During the install (or at a later time), a synchronization action can be performed to retrieve receipts from a remote server environment. The receipts can be authenticated (e.g., by the installed app and/or by a receipt service running on the mobile device). The authenticated receipts can be processed by the apps (e.g., to provide access to the content purchased by the user that is associated with the receipts).

In some implementations, digital receipts are managed based on the type of purchased content. Types of purchased content include durable content and consumable content. Durable content refers to content that is purchased once and can be used on multiple devices (e.g., on multiple devices that are all owned by one user or are associated with one account) and that can be reused (e.g., used when an application is installed on a new device and/or used when an application is reinstalled on an existing device). Examples of durable content include digital song files, movie files, new levels or expansions for a game application, etc. Consumable content refers to content that can only be used (e.g., redeemed) once. In a specific implementation, consumable content is tied to the specific device for which the purchase was made (e.g., tied to a specific device context). Examples of consumable content include in-game assets (e.g., in-game money such as gold, in-game items, etc.).

Synchronization operations can take into account the type of purchased content. For example, if an application is being installed on a new device, then all digital receipts for durable content can be downloaded when the new application is installed or first activated. Digital receipts for consumable content may not be downloaded when the new application is installed or first activated if they have already been used (e.g., redeemed). In some implementations, digital receipts for consumable content can still be downloaded but not used (e.g., to have a record of past purchases even though the content cannot be redeemed again).

Digital receipts can be utilized by an application publisher/developer (ISV). For example, an ISV can read digital receipts (e.g., using an application programming interface (API)) and provide certain information about the digital receipts (e.g., some or all of the meta-data) to the ISV's servers (e.g., to track and/or fulfill purchases).

In some implementations, the following example pseudo-code can be used to perform various synchronization operations:

On App First Install

If App(MY_APP).IAPCount > 0 then

WPS.GetReceipts (Since:null, MY_APP, out

| | |
|---|---|
| NewReceipts) | SaveAndDeDupeReceipts (NewReceipts) |

On Purchase IAP

If ReceiptCount > 0 then

WPS.GetReceipts (Since:[Newest Receipt Purchase

Date], MY_APP, out NewReceipts)

Else

WPS.GetReceipts (Since:null, MY_APP, out

NewReceipts)

SaveAndDeDupeReceipts (NewReceipts)
CheckIfIAPIsInReceiptStore (lookup: iapID, out

iapIsOwned)

If iapIsOwned then

Show: Redownload Prompt

Else

Show: Purchase prompt

Nightly Receipt Sync

If [Last Nightly Sync Timestamp] exists then

[Last Nightly Sync Timestamp] = GetReceipts

(Since:[Last Nightly Sync Timestamp], FOR_ALL_APPS, out
NewReceipts)

Else

[Last Nightly Sync Timestamp] = GetReceipts

(Since:null, FOR_ALL_APPS, out NewReceipts)

| | |
|---|---|
| SaveAndDeDupeReceipts (NewReceipts) | // discards |

receipts for apps you don't have installed

In some implementations, management of digital receipts can include one or more of the following features:
Ability to securely demonstrate ownership of any type of content or service offline without prior knowledge of the type of content (e.g., the digital signature of the digital receipt associated with the content can be authenticated offline).
Ability to demonstrate ownership is portable, and can be distributed from one system to another with or without the associated content or service.
Unique identification of the user and the context (e.g., the mobile device) from which the original purchase of the content was made. Unique identification can be performed using anonymized unique identifiers.
Ability to reconstruct a collection of purchased (e.g., owned) content (e.g., all purchased content, including durable and/or consumable content) in an optimized fashion which can reduce the amount of data transferred between the server environment and the computing devices (e.g., clients).

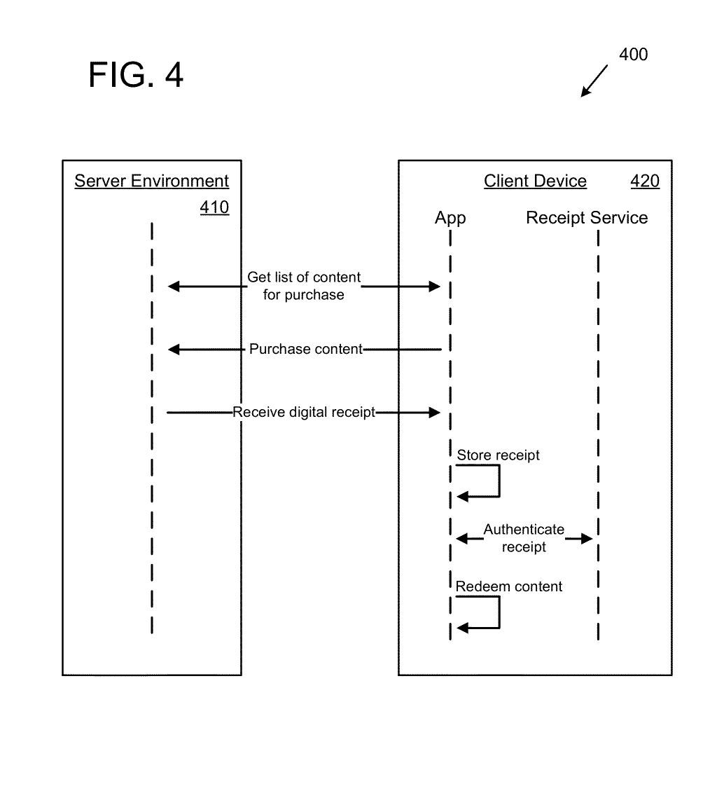

FIG. 4 is a diagram of an example control flow 400 for making a purchase and generating a digital receipt. The example control flow 400 depicts a server environment 410 and a client device 420 (e.g., a mobile computing device). The example control flow 400 also depicts the interaction of operations between the server environment 410 and the client device 420. For example, the control flow 400 depicts the client device 420 performing operations to get a list of content (e.g., content available for purchase for a specific local application), purchasing content, receive a digital receipt for the purchased content, storing the digital receipt (e.g., in a local receipt store), authenticating the received digital receipt (via a local receipt service) and redeeming the content once the digital receipt has been authenticated. In the example control flow 400, the client device 420 depicts operations involving an application (app) running on the client device and a receipt service running on the client device.

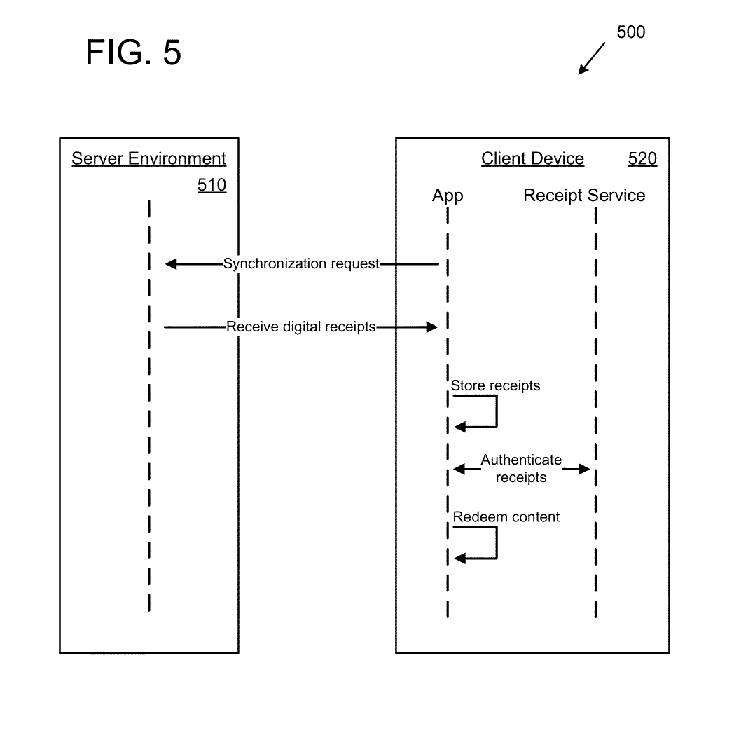

FIG. 5 is a diagram of an example control flow 500 for synchronizing digital receipts. The example control flow 500 depicts a server environment 510 and a client device 520 (e.g., a mobile computing device). The example control flow 500 also depicts the interaction of operations between the server environment 510 and the client device 520. For example, the control flow 500 depicts the client device 520 performing operations to initiate a synchronization request. The synchronization request can comprise a last synchronization timestamp. The synchronization request can be a request to synchronize digital receipts for one or more applications installed on the client device 520 (e.g., synchronize digital receipts that are new and/or updated since the last synchronization timestamp). The client device 520 receives digital receipts in response to the synchronization request, stores the received digital receipts (e.g., in a local receipt store) authenticates the received digital receipts (e.g., using a local receipt service), and redeems content as needed once the digital receipts have been authenticated.

### Example 8

### Computing Systems

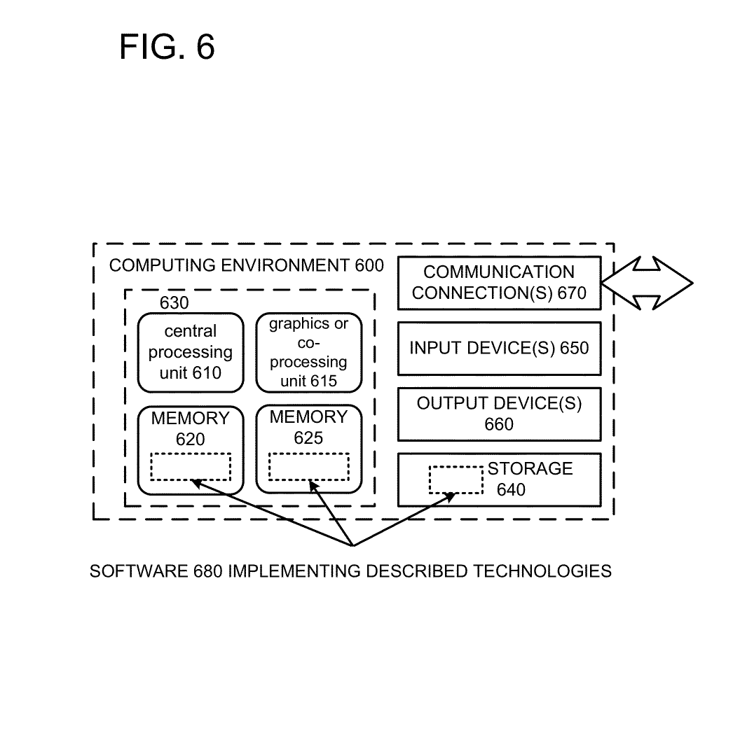

FIG. 6 depicts a generalized example of a suitable computing system 600 in which the described innovations may be implemented. The computing system 600 is not intended to suggest any limitation as to scope of use or functionality, as the innovations may be implemented in diverse general-purpose or special-purpose computing systems.

With reference to FIG. 6, the computing system 600 includes one or more processing units 610, 615 and memory 620, 625. In FIG. 6, this basic configuration 630 is included within a dashed line. The processing units 610, 615 execute computer-executable instructions. A processing unit can be a general-purpose central processing unit (CPU), processor in an application-specific integrated circuit (ASIC) or any other type of processor. In a multi-processing system, multiple processing units execute computer-executable instructions to increase processing power. For example, FIG. 6 shows a central processing unit 610 as well as a graphics processing unit or co-processing unit 615. The tangible memory 620, 625 may be volatile memory (e.g., registers, cache, RAM), non-volatile memory (e.g., ROM, EEPROM, flash memory, etc.), or some combination of the two, accessible by the processing unit(s). The memory 620, 625 stores software 680 implementing one or more innovations described herein, in the form of computer-executable instructions suitable for execution by the processing unit(s).

A computing system may have additional features. For example, the computing system 600 includes storage 640, one or more input devices 650, one or more output devices 660, and one or more communication connections 670. An interconnection mechanism (not shown) such as a bus, controller, or network interconnects the components of the computing system 600. Typically, operating system software (not shown) provides an operating environment for other software executing in the computing system 600, and coordinates activities of the components of the computing system 600.

The tangible storage 640 may be removable or non-removable, and includes magnetic disks, magnetic tapes or cassettes, CD-ROMs, DVDs, or any other medium which can be used to store information and which can be accessed within the computing system 600. The storage 640 stores instructions for the software 680 implementing one or more innovations described herein.

The input device(s) 650 may be a touch input device such as a keyboard, mouse, pen, or trackball, a voice input device, a scanning device, or another device that provides input to the computing system 600. For video encoding, the input device(s) 650 may be a camera, video card, TV tuner card, or similar device that accepts video input in analog or digital form, or a CD-ROM or CD-RW that reads video samples into the computing system 600. The output device(s) 660 may be a display, printer, speaker, CD-writer, or another device that provides output from the computing system 600.

The communication connection(s) 670 enable communication over a communication medium to another computing entity. The communication medium conveys information such as computer-executable instructions, audio or video input or output, or other data in a modulated data signal. A modulated data signal is a signal that has one or more of its characteristics set or changed in such a manner as to encode information in the signal. By way of example, and not limitation, communication media can use an electrical, optical, RF, or other carrier.

The innovations can be described in the general context of computer-executable instructions, such as those included in program modules, being executed in a computing system on a target real or virtual processor. Generally, program modules include routines, programs, libraries, objects, classes, components, data structures, etc. that perform particular tasks or implement particular abstract data types. The functionality of the program modules may be combined or split between program modules as desired in various embodiments. Computer-executable instructions for program modules may be executed within a local or distributed computing system.

The terms “system” and “device” are used interchangeably herein. Unless the context clearly indicates otherwise, neither term implies any limitation on a type of computing system or computing device. In general, a computing system or computing device can be local or distributed, and can include any combination of special-purpose hardware and/or general-purpose hardware with software implementing the functionality described herein.

For the sake of presentation, the detailed description uses terms like “determine” and “use” to describe computer operations in a computing system. These terms are high-level abstractions for operations performed by a computer, and should not be confused with acts performed by a human being. The actual computer operations corresponding to these terms vary depending on implementation.

### Example 9

### Mobile Device

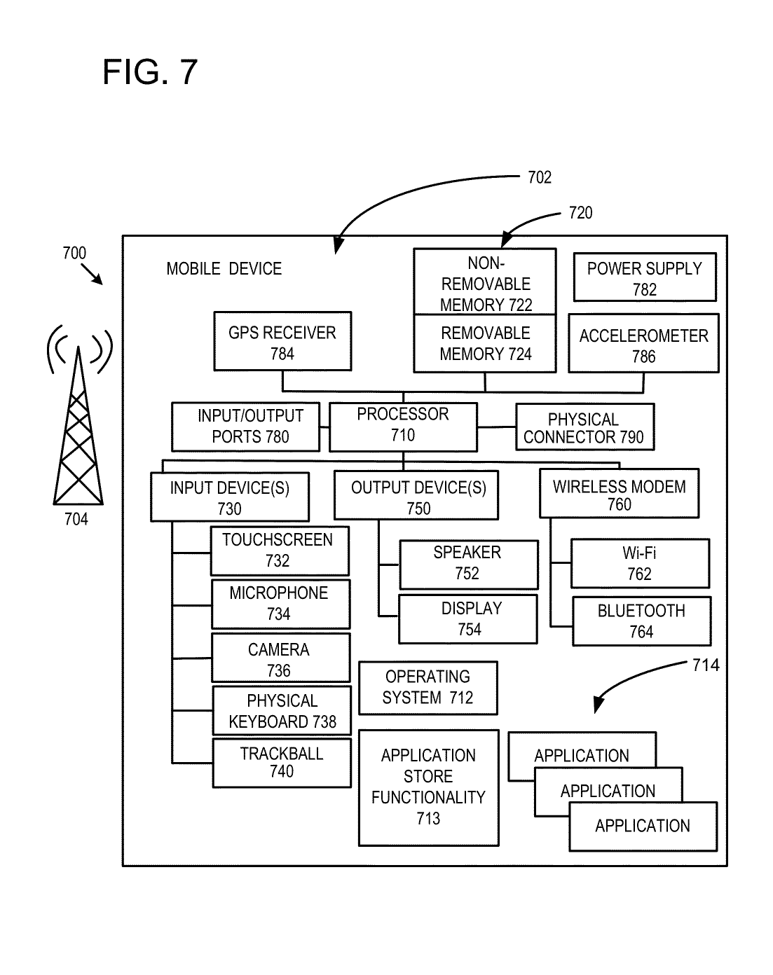

FIG. 7 is a system diagram depicting an exemplary mobile device 700 including a variety of optional hardware and software components, shown generally at 702. Any components 702 in the mobile device can communicate with any other component, although not all connections are shown, for ease of illustration. The mobile device can be any of a variety of computing devices (e.g., cell phone, smartphone, handheld computer, Personal Digital Assistant (PDA), etc.) and can allow wireless two-way communications with one or more mobile communications networks 704, such as a cellular, satellite, or other network.

The illustrated mobile device 700 can include a controller or processor 710 (e.g., signal processor, microprocessor, ASIC, or other control and processing logic circuitry) for performing such tasks as signal coding, data processing, input/output processing, power control, and/or other functions. An operating system 712 can control the allocation and usage of the components 702 and support for one or more application programs 714. The application programs can include common mobile computing applications (e.g., email applications, calendars, contact managers, web browsers, messaging applications), or any other computing application. Functionality 713 for accessing an application store can also be used for acquiring and updating application programs 714.

The illustrated mobile device 700 can include memory 720. Memory 720 can include non-removable memory 722 and/or removable memory 724. The non-removable memory 722 can include RAM, ROM, flash memory, a hard disk, or other well-known memory storage technologies. The removable memory 724 can include flash memory or a Subscriber Identity Module (SIM) card, which is well known in GSM communication systems, or other well-known memory storage technologies, such as “smart cards.” The memory 720 can be used for storing data and/or code for running the operating system 712 and the applications 714. Example data can include web pages, text, images, sound files, video data, or other data sets to be sent to and/or received from one or more network servers or other devices via one or more wired or wireless networks. The memory 720 can be used to store a subscriber identifier, such as an International Mobile Subscriber Identity (IMSI), and an equipment identifier, such as an International Mobile Equipment Identifier (IMEI). Such identifiers can be transmitted to a network server to identify users and equipment.

The mobile device 700 can support one or more input devices 730, such as a touchscreen 732, microphone 734, camera 736, physical keyboard 738 and/or trackball 740 and one or more output devices 750, such as a speaker 752 and a display 754. Other possible output devices (not shown) can include piezoelectric or other haptic output devices. Some devices can serve more than one input/output function. For example, touchscreen 732 and display 754 can be combined in a single input/output device.

The input devices 730 can include a Natural User Interface (NUI). An NUI is any interface technology that enables a user to interact with a device in a “natural” manner, free from artificial constraints imposed by input devices such as mice, keyboards, remote controls, and the like. Examples of NUI methods include those relying on speech recognition, touch and stylus recognition, gesture recognition both on screen and adjacent to the screen, air gestures, head and eye tracking, voice and speech, vision, touch, gestures, and machine intelligence. Other examples of a NUI include motion gesture detection using accelerometers/gyroscopes, facial recognition, 3D displays, head, eye, and gaze tracking, immersive augmented reality and virtual reality systems, all of which provide a more natural interface, as well as technologies for sensing brain activity using electric field sensing electrodes (EEG and related methods). Thus, in one specific example, the operating system 712 or applications 714 can comprise speech-recognition software as part of a voice user interface that allows a user to operate the device 700 via voice commands. Further, the device 700 can comprise input devices and software that allows for user interaction via a user's spatial gestures, such as detecting and interpreting gestures to provide input to a gaming application.

A wireless modem 760 can be coupled to an antenna (not shown) and can support two-way communications between the processor 710 and external devices, as is well understood in the art. The modem 760 is shown generically and can include a cellular modem for communicating with the mobile communication network 704 and/or other radio-based modems (e.g., Bluetooth 764 or Wi-Fi 762). The wireless modem 760 is typically configured for communication with one or more cellular networks, such as a GSM network for data and voice communications within a single cellular network, between cellular networks, or between the mobile device and a public switched telephone network (PSTN).

The mobile device can further include at least one input/output port 780, a power supply 782, a satellite navigation system receiver 784, such as a Global Positioning System (GPS) receiver, an accelerometer 786, and/or a physical connector 790, which can be a USB port, IEEE 1394 (FireWire) port, and/or RS-232 port. The illustrated components 702 are not required or all-inclusive, as any components can be deleted and other components can be added.

### Example 10

### Cloud-Supported Environment

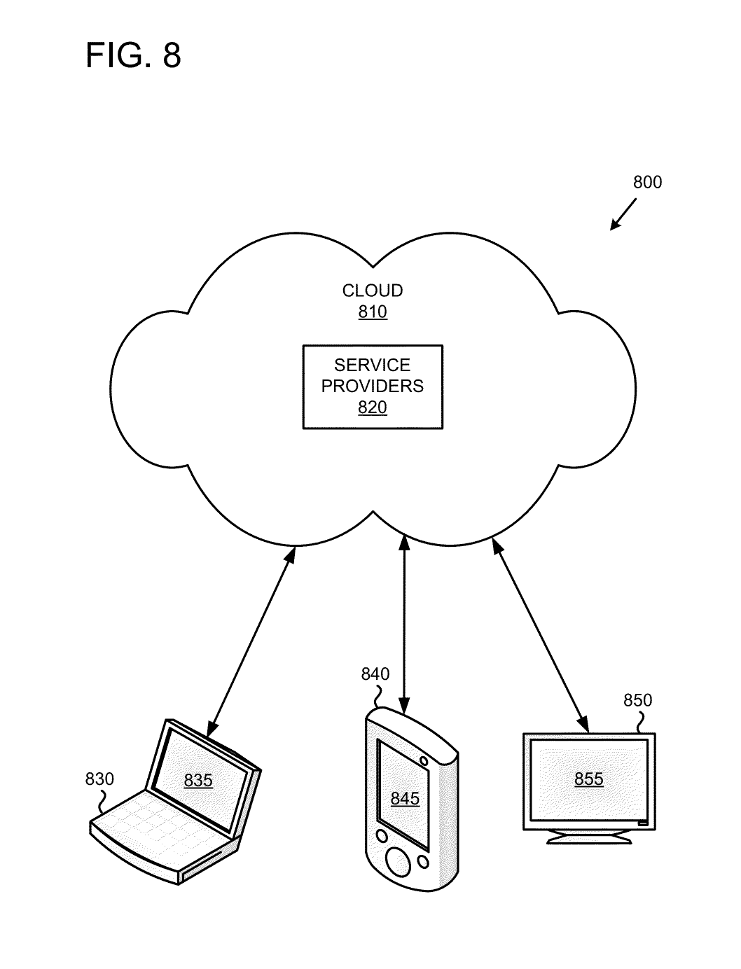

FIG. 8 illustrates a generalized example of a suitable implementation environment 800 in which described embodiments, techniques, and technologies may be implemented. In the example environment 800, various types of services (e.g., computing services) are provided by a cloud 810. For example, the cloud 810 can comprise a collection of computing devices, which may be located centrally or distributed, that provide cloud-based services to various types of users and devices connected via a network such as the Internet. The implementation environment 800 can be used in different ways to accomplish computing tasks. For example, some tasks (e.g., processing user input and presenting a user interface) can be performed on local computing devices (e.g., connected devices 830, 840, 850) while other tasks (e.g., storage of data to be used in subsequent processing) can be performed in the cloud 810.

In example environment 800, the cloud 810 provides services for connected devices 830, 840, 850 with a variety of screen capabilities. Connected device 830 represents a device with a computer screen 835 (e.g., a mid-size screen). For example, connected device 830 could be a personal computer such as desktop computer, laptop, notebook, netbook, or the like. Connected device 840 represents a device with a mobile device screen 845 (e.g., a small size screen). For example, connected device 840 could be a mobile phone, smart phone, personal digital assistant, tablet computer, and the like. Connected device 850 represents a device with a large screen 855. For example, connected device 850 could be a television screen (e.g., a smart television) or another device connected to a television (e.g., a set-top box or gaming console) or the like. One or more of the connected devices 830, 840, 850 can include touch screen capabilities. Touchscreens can accept input in different ways. For example, capacitive touchscreens detect touch input when an object (e.g., a fingertip or stylus) distorts or interrupts an electrical current running across the surface. As another example, touchscreens can use optical sensors to detect touch input when beams from the optical sensors are interrupted. Physical contact with the surface of the screen is not necessary for input to be detected by some touchscreens. Devices without screen capabilities also can be used in example environment 800. For example, the cloud 810 can provide services for one or more computers (e.g., server computers) without displays.

Services can be provided by the cloud 810 through service providers 820, or through other providers of online services (not depicted). For example, cloud services can be customized to the screen size, display capability, and/or touch screen capability of a particular connected device (e.g., connected devices 830, 840, 850).

In example environment 800, the cloud 810 provides the technologies and solutions described herein to the various connected devices 830, 840, 850 using, at least in part, the service providers 820. For example, the service providers 820 can provide a centralized solution for various cloud-based services. The service providers 820 can manage service subscriptions for users and/or devices (e.g., for the connected devices 830, 840, 850 and/or their respective users).

### Example 11

### Implementations

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed methods can be used in conjunction with other methods.

Any of the disclosed methods can be implemented as computer-executable instructions or a computer program product stored on one or more computer-readable storage media and executed on a computing device (e.g., any available computing device, including smart phones or other mobile devices that include computing hardware). Computer-readable storage media are any available tangible media that can be accessed within a computing environment (e.g., one or more optical media discs such as DVD or CD, volatile memory components (such as DRAM or SRAM), or nonvolatile memory components (such as flash memory or hard drives)). By way of example and with reference to FIG. 6, computer-readable storage media include memory 620 and 625, and storage 640. By way of example and with reference to FIG. 7, computer-readable storage media include memory and storage 720, 722, and 724. The term computer-readable storage media does not include communication connections (e.g., 670, 760, 762, and 764) such as signals and carrier waves.

Any of the computer-executable instructions for implementing the disclosed techniques as well as any data created and used during implementation of the disclosed embodiments can be stored on one or more computer-readable storage media. The computer-executable instructions can be part of, for example, a dedicated software application or a software application that is accessed or downloaded via a web browser or other software application (such as a remote computing application). Such software can be executed, for example, on a single local computer (e.g., any suitable commercially available computer) or in a network environment (e.g., via the Internet, a wide-area network, a local-area network, a client-server network (such as a cloud computing network), or other such network) using one or more network computers.

For clarity, only certain selected aspects of the software-based implementations are described. Other details that are well known in the art are omitted. For example, it should be understood that the disclosed technology is not limited to any specific computer language or program. For instance, the disclosed technology can be implemented by software written in C++, Java, Perl, JavaScript, Adobe Flash, or any other suitable programming language. Likewise, the disclosed technology is not limited to any particular computer or type of hardware. Certain details of suitable computers and hardware are well known and need not be set forth in detail in this disclosure.

Furthermore, any of the software-based embodiments (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means.

The disclosed methods, apparatus, and systems should not be construed as limiting in any way. Instead, the present disclosure is directed toward all novel and nonobvious features and aspects of the various disclosed embodiments, alone and in various combinations and sub combinations with one another. The disclosed methods, apparatus, and systems are not limited to any specific aspect or feature or combination thereof, nor do the disclosed embodiments require that any one or more specific advantages be present or problems be solved.

The technologies from any example can be combined with the technologies described in any one or more of the other examples. In view of the many possible embodiments to which the principles of the disclosed technology may be applied, it should be recognized that the illustrated embodiments are examples of the disclosed technology and should not be taken as a limitation on the scope of the disclosed technology. Rather, the scope of the disclosed technology includes what is covered by the following claims. We therefore claim as our invention all that comes within the scope and spirit of the claims.

We claim:

1. A method, implemented at least in part by a mobile computing device, for managing digital receipts for purchases, the method comprising:
by the mobile computing device when offline:
receiving, from a local application running on the mobile computing device, a request for digital receipts associated with the local application;
obtaining, from a receipt store of the mobile computing device, digital receipts associated with the local application; and
providing, to the local application, the obtained digital receipts;
wherein the obtained digital receipts are authenticated locally by the mobile computing device.

2. The method of claim 1 wherein the obtained digital receipts are authenticated locally by the mobile computing device using one or more digital signatures associated with the obtained digital receipts.

3. The method of claim 1 further comprising:
by the mobile computing device when offline:
authenticating the obtained digital receipts using a receipt service of the mobile computing device.

4. The method of claim 3 further comprising:
based on results of the authenticating, determining that the obtained digital receipts are authentic; and
redeeming content associated with the authentic digital receipts.

5. The method of claim 1 wherein the obtained digital receipts are processed by the local application to determine one or more purchase transactions associated with the local application.

6. The method of claim 5 wherein the one or more purchase transactions are for purchases of content utilized by the local application, wherein the content is one of durable content and consumable content.

7. The method of claim 1 further comprising:
by the mobile computing device when online:
receiving the digital receipts from a remote server, wherein the digital receipts are signed using a digital signature; and
storing the digital receipts in the receipt store.

8. The method of claim 1 wherein a digital receipt comprises meta-data, the meta-data comprising:
a unique purchase identifier;
a unique user identifier; and
a unique mobile computing device identifier.

9. A method, implemented at least in part by a mobile computing device, for managing digital receipts for purchases, the method comprising:
by the mobile computing device, performing a delta sync comprising:
obtaining a last synchronization timestamp;
sending the last synchronization timestamp to a server environment;
receiving, from the server environment, one or more digital receipts, wherein the one or more digital receipts are new since the last synchronization timestamp and/or have been updated since the last synchronization timestamp; and
saving the received one or more digital receipts in a receipt store of the mobile computing device.

10. The method of claim 9 wherein last synchronization timestamp is associated with a local application of the mobile computing device, and wherein the received one or more digital receipts are associated with the local application.

11. The method of claim 9 wherein the delta sync is performed by the mobile computing device after the mobile computing device connects to the server environment for a purpose other than to synchronize digital receipts.

12. The method of claim 9 wherein the delta sync is performed as an opportunistic synchronization.

13. The method of claim 9 wherein the delta sync is performed when a local application connects to the server environment to make a purchase of content.

14. The method of claim 9 wherein last synchronization timestamp is associated with a local application of the mobile computing device, and wherein the delta sync is performed only for digital receipts associated with the local application.

15. The method of claim 9 wherein the delta sync is performed by the mobile computing device to synchronize digital receipts for all applications installed on the mobile computing device that could have new and/or updated digital receipts to receive.

16. A server system comprising:
one or more processing units;
memory; and
one or more computer-readable storage media storing computer-executable instructions for causing the server system to perform operations for managing digital receipts for purchases comprising:
receiving, from a mobile computing device, a purchase request related to an application on the mobile computing device, wherein the purchase request is for one of durable content and consumable content for the application on the mobile computing device; and
in response to the purchase request, sending a digitally signed digital receipt for the purchase to the mobile computing device;
wherein the digitally signed digital receipt supports authentication of the purchase at the mobile computing device when the mobile computing device is not connected to the server system.

17. The server system of claim 16 wherein the operations further comprise:
receiving, from the mobile computing device, a request to synchronize digital receipts;
in response to the request to synchronize digital receipts, sending digitally signed digital receipts to the mobile computing device, wherein the digitally signed digital receipts support authentication at the mobile computing device when the mobile computing device is not connected to the server system.

18. The server system of claim 16 wherein the operations further comprise:
receiving, from the mobile computing device, a last synchronization timestamp;
sending, to the mobile computing device, one or more digitally signed digital receipts, wherein the one or more digitally signed digital receipts are new since the last synchronization timestamp and/or have been updated since the last synchronization timestamp.

19. The server system of claim 18 wherein last synchronization timestamp is associated with a local application of the mobile computing device, and wherein the sent one or more digitally signed digital receipts are associated with the local application.

20. The server system of claim 16 wherein the digitally signed digital receipt comprises:
a unique purchase identifier;
a unique user identifier; and
a unique mobile computing device identifier.
